(19) United States
(12) Patent Application Publication
(10) Pub. No.: US 2015/0173569 A1
(43) Pub. Date: Jun. 25, 2015

(54) Towel

(71) Applicant: Nelda J. Griggs, DeSoto, TX (US)

(72) Inventor: Nelda J. Griggs, DeSoto, TX (US)

(21) Appl. No.: 14/563,286

(22) Filed: Dec. 8, 2014

Related U.S. Application Data
(60) Provisional application No. 61/920,269, filed on Dec. 23, 2013.

(51) Int. Cl. A47K 7/02; A61H 23/00; A47K 10/02

(52) U.S. Cl. CPC A47K 7/02; A47K 10/02; A61H 23/00

(57) ABSTRACT

A towel comprising a main body portion, main body ends, and a strap comprising first and second strap ends is provided. In the preferred embodiment, the main body portion may be formed from an elongated length of material forming a base layer and natural or synthetic fibers extending from the base layer. Each strap end may extend beyond the ends of the main body portion, allowing a use to easily grasp each strap end and manipulate the towel as desired. The strap may be formed from absorbent material. A hooped portion may be coupled to one end of the main body portion, which permits the towel to be suspended from a hook to be air dried.

This application claims the benefit of provisional application Ser. No. 61/920,269 filed Dec. 23, 2013, the contents of which are incorporated by reference herein its entirety.

### BACKGROUND OF THE INVENTION

1. Field of the Invention

The present invention relates generally to a towel and specifically to a towel adapted for use by persons with disabilities.

2. Description of the Prior Art

Many people with temporary or permanent disabilities find it difficult to perform tasks that others without such disabilities find little difficulty in performing. Daily personal hygiene is one such task that many able bodied individuals take for granted. Tending to personal hygiene often requires manipulation of cloths, sponges, and other cleaning devices, so as to clean hard to reach areas of the body. Persons with limited mobility may forego maintaining proper hygiene because they lack the necessary flexibility or manual dexterity to do so. Because of this issue, many people are required to enlist the help of family members, friends, and hired caretakers to help with daily personal hygiene activities. Persons requiring such assistance often lose their feeling of independence and autonomy.

What is needed is a device that permits people of all levels of physical abilities to maintain a satisfactory level of daily hygiene without having to enlist other people to help. The device of the present invention allows people of all levels of physical abilities to maintain their independence and perform daily hygiene tasks.

### SUMMARY OF THE INVENTION

The towel of the preferred embodiment generally comprises a main body portion comprising main body ends; and a strap comprising first and second strap ends. The main body portion comprises an elongated length of material comprising a base layer and natural or synthetic fibers extending from the base layer. These fibers are absorbent such that the towel may be used to absorb water and other fluids and may be used to scrub a surface such as the human skin.

Extending from the ends of the main body portion are the strap ends. In the preferred embodiment, each strap end preferably extends a length of between four and five inches beyond the respective end of the main body portion. This length permits a user to easily grasp the towel by each strap end and manipulate the towel in a desired manner. In the preferred embodiment, the strap is formed from a single piece of material that extends beyond the two ends of the main body portion such that the two strap ends are formed.

In other embodiments, each strap end is coupled to a lower or rear surface of the main body portion and extends outward from the main body portion when the towel is laid flat. One or both the strap ends comprise a hook and/or loop portion adapted to act cooperatively with a hook and/or loop portion positioned on an under surface of the strap. This cooperative hook and loop arrangement permits the towel to be maintained in a rolled position.

In other embodiments, the towel comprises a plurality of string-like projections. In such embodiments, these string-like absorbent projections are composed of cotton or micro-fibers.

The main body portion may be of many different designs and colors. In some embodiments, the strap comprises a hook and/or loop portion adapted to act cooperatively with a hook and/or loop portion positioned on an under-surface of the main body portion. This arrangement permits the main body portion to be separated from the strap.

In some embodiments, the towel comprises a hooped portion. This hooped portion is coupled to one end of the main body portion and permits the towel to by suspended from a hook, such that for example, the towel may be air dried.

### BRIEF DESCRIPTION OF THE DRAWINGS

FIG. 1 is a perspective view of the towel, in accordance with a preferred embodiment.

FIG. 2 is a perspective view of the towel of FIG. 1, in a rolled position.

FIG. 3 is a perspective view of the towel, in accordance with another embodiment.

FIG. 4 is a perspective view of the towel of FIG. 3, in a rolled position.

FIG. 5 is a close-up view of ends of the towels of FIGS. 1 and 3, in accordance with a preferred embodiment.

FIG. 6 is a rear perspective view of the towel of FIG. 3, in accordance with another embodiment.

FIG. 7 is a top-side plan view of the towel, in accordance with another embodiment.

FIG. 8 is a top-side plan view of the towel, in accordance with another embodiment.

### DESCRIPTION OF THE PREFERRED EMBODIMENT

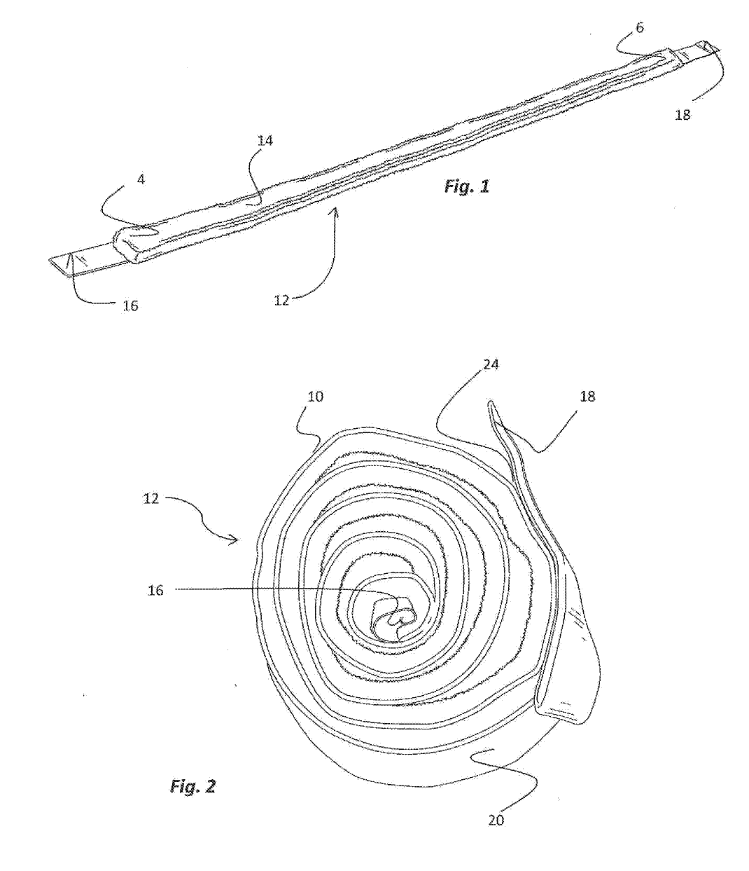

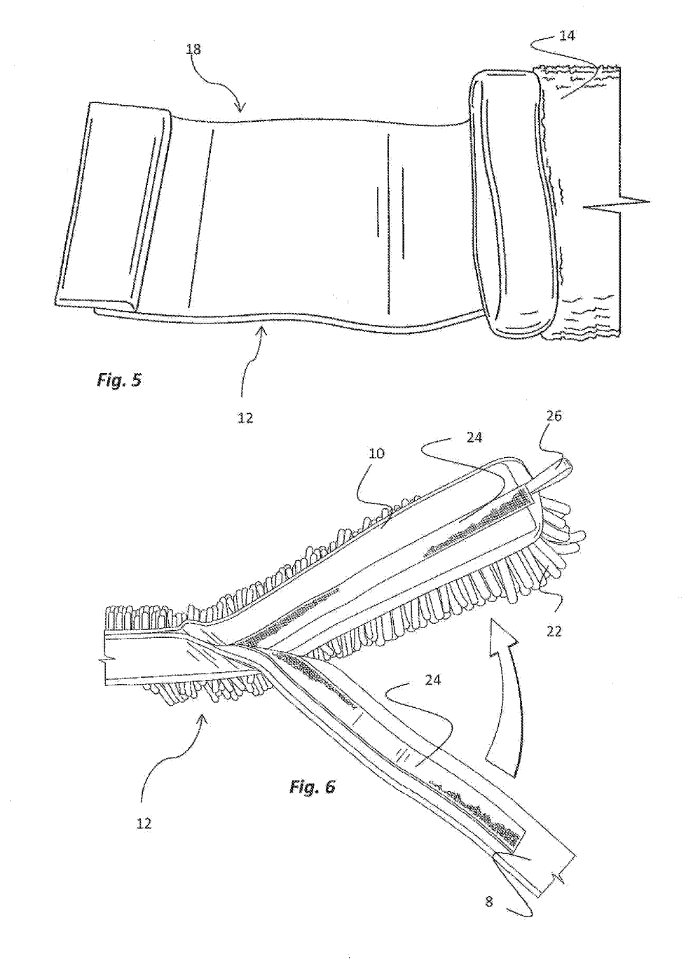

Referring to FIGS. 1-8, there is shown the towel 12 in accordance with a preferred embodiment. As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation. The detailed description illustrates by way of example, not by way of limitation, the principles of the invention. This description will clearly enable one skilled in the art to make and use the invention, and describes several embodiments, adaptations, variations, alternatives, and uses of the invention, including what is presently believed to be the best mode of carrying out the invention.

### General Overview

As a general overview, the towel 12 of the preferred embodiment generally comprises a main body portion 14 comprising main body ends 4, 6; and a strap 8 comprising first and second strap ends 16, 18. The main body portion 14 comprises an elongated length of material comprising a base layer 10 and natural or synthetic fibers extending from the base layer 10. These fibers are absorbent such that the towel 12 may be used to absorb water and other fluids and may be used to scrub a surface such as the human skin. In the preferred embodiment, the main body portion 14 is terry cloth formed from standard cotton. Other cotton's such as Egyptian or pima cotton may also be used. Although the main body portion 14 of the preferred embodiment is terry cloth comprising cotton, other suitable fabrics and materials may be used such as those formed from nylon, rayon, or micro-fibers. In other embodiments fibers formed from hemp or bamboo may be used. In some embodiments, the main body portion 14 is formed from a combination of natural and synthetic fibers.

In the preferred embodiment, the main body portion 14 is approximately four feet long and approximately four inches wide. However, the main body portion 14 may be longer or shorter than four feet or wider or narrower than four inches without departing from the scope and spirit of the present invention. Extending from the ends 4, 6 of the main body portion 14 are the strap ends 16, 18. In the preferred embodiment, each strap end 16, 18 preferably extends a length of between four and five inches beyond the respective end 4, 6 of the main body portion 14. This length permits a user to easily grasp the towel 12 by each strap end 16, 18 and manipulate the towel 12 in a desired manner. In the preferred embodiment the strap 8 is formed from a single piece of material that extends beyond the two ends 4, 6 of the main body portion 14 such that the two strap ends 16, 18 are formed. In other embodiments, each strap end 16, 18 is coupled to a lower or rear surface of the main body portion 14 and extends outward from the main body portion 14 when the towel 12 is laid flat as shown in FIG. 1. One or both the strap ends 16, 18 comprise a hook and/or loop portion 24 adapted to act cooperatively with a hook and/or loop portion 24 positioned on an under-surface 20 of the strap 8. This cooperative hook and loop 24 arrangement permits the towel 12 to be maintained in a rolled position, as shown, for example, in FIG. 2. In such embodiments, the strap end 16, 18 hook and loop portion 24 engages with the strap 8 under surface 20 hook and loop portion 24.

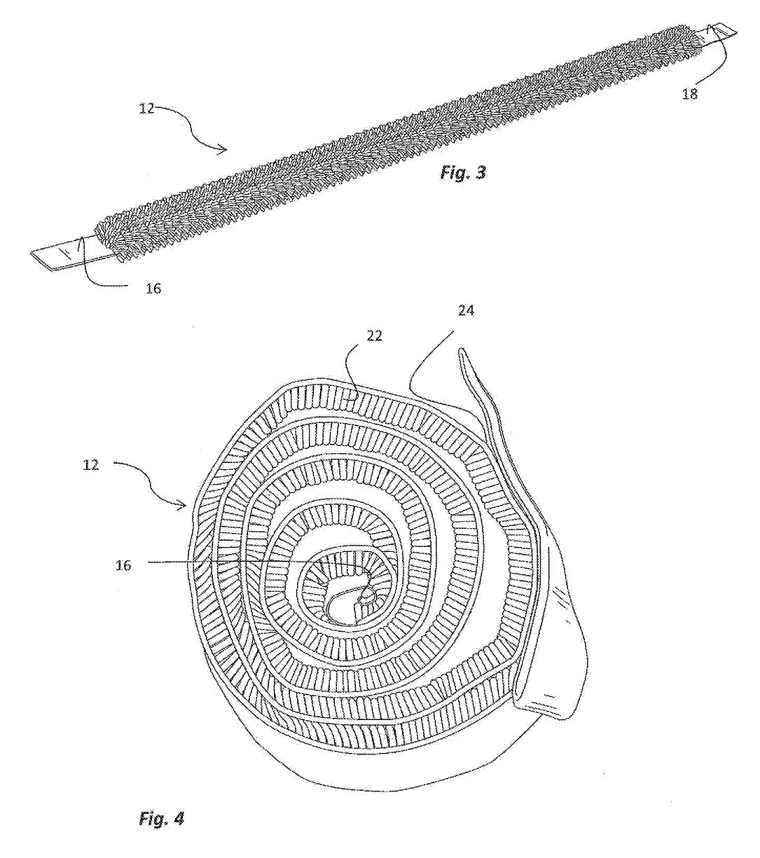

Referring to FIGS. 3, 4 & 6, in other embodiments, the towel 12 comprises a plurality of string-like projections 22. In such embodiments, these string-like absorbent projections 22 are composed of cotton or micro-fibers. Although the absorbent projections 22 of these embodiments comprise cotton, other suitable materials may be used such as nylon, rayon. In other embodiments absorbent projections 22 formed from hemp or bamboo may be used. In some embodiments, the absorbent projections 22 are formed from a combination of natural and synthetic fibers. Extending from the ends 4, 6 of the main body portion 14 are the strap ends 16, 18. The strap 8 is formed from a single piece of material that extends beyond the two ends of the main body portion 14 such that the two strap ends 16, 18 are formed. In other embodiments, each strap end 16, 18 is coupled to a lower or rear surface of the main body portion 14 and extends outward from the main body portion 14 when the towel 12 is laid flat as shown in FIG. 3. In these embodiments, each strap end 16, 18 preferably extends a length of between four and five inches beyond the respective end of the main body portion 14. One or both the strap ends 16, 18 comprise a hook and/or loop portion 24 adapted to act cooperatively with a hook and/or loop portion 24 positioned on an under-surface 20 of the strap 8. This cooperative hook and loop 24 arrangement permits the towel 12 to be maintained in a rolled position, as shown, for example, in FIG. 4. In such embodiments, the upper 16, 18 hook and loop portion engages with the under surface 20 hook and loop portion 24.

The mail body portion 14 may be of many different designs and colors. Referring to FIG. 6, in some embodiments, the strap 8 comprises a hook and/or loop portion 24 adapted to act cooperatively with a hook and/or loop portion 24 positioned on an under-surface 20 of the main body portion 14. This arrangement permits the main body portion 14 to be separated from the strap 8. This arrangement permits the user to change-out main body portions 14 while using the same strap 8. This is particularly useful when the user desires, for example, to wash the main body portion 14.

This arrangement also permits the user to use different main body portions 14 of different designs and configurations without having to use a separate strap 8. This arrangement further permits the user to use the strap 8 to scratch or scrub without the main body portion 14 being attached. This arrangement also permits the user to use the main body portion 14 as a wrap or “turban” without the strap 8 or use the main body portion 14 as a conventional towel. For example, the user may choose to take only the main body portion 14 to the pool or beach.

In some embodiments, the towel 12 comprises a hooped portion 26. This hooped portion 26 is coupled to one end of the main body portion 14 and permits the towel 12 to be suspended from a hook, such that for example, the towel 12 may be air dried.

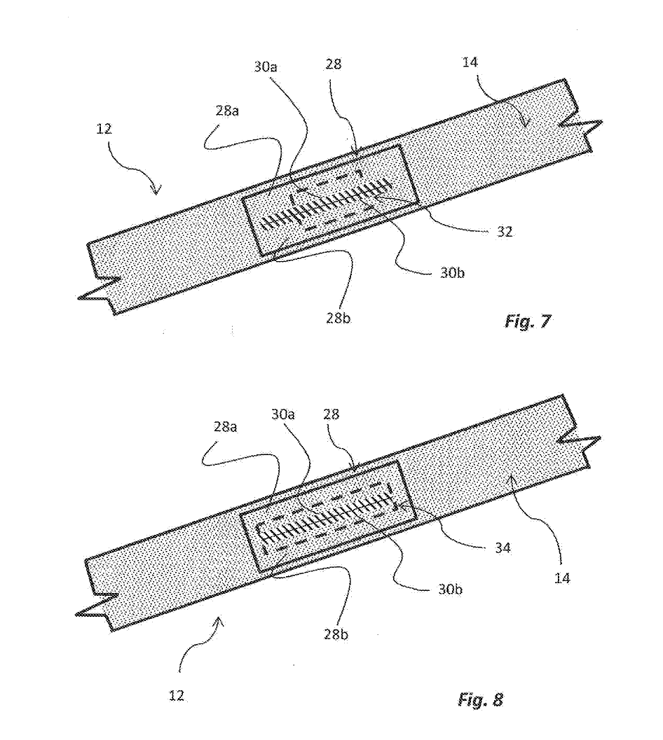

In some embodiments, the towel 12 comprises a compartment 28 or pocket 28. In these embodiments, the pocket 28 is within the main body portion 14 as shown in FIGS. 7 and 8. The pocket 28 comprises sides 28a and 28b. The sides 28a and 28b comprise cooperative coupling members 30a and 30b to permit the sides 28a and 28b to be drawn together or moved apart to allow an object to be placed within and contained by the pocket 28. In a preferred embodiment, the cooperative coupling members 30a and 30b comprise a zipper arrangement. However, the cooperative coupling members 30a and 30b need not comprise a zipper arrangement. Rather such cooperative coupling members 30a and 30b may comprise a hook and loop arrangement, snaps, buttons, ties, or other suitable fasteners known in the art.

Referring to FIG. 7 in a preferred embodiment, the towel 12 comprises a conventional and commercially available hot/cold pack 32 such as an ice pack 32 or gel pack 32 comprising a sac filled with water, refrigerant gel or other suitable liquid. Preferably, such hot/cold pack 32 is adapted to retain heat or refrigeration. Thus, the towel 12 comprising the hot/cold pack 32 may be used, for example, as a cold or hot compress to alleviate pain caused by minor injuries or muscle soreness.

Referring to FIG. 8, in a preferred embodiment, the towel 12 comprises a conventional and commercially available vibration unit 34. Preferably, such vibration unit 34 is adapted to vibrate and cause movement against a body part against which it is pressed. Thus, the towel 12 comprising the vibration unit 34 may be used, for example, as a massage device to alleviate pain caused by minor injuries or muscle soreness.

In some embodiments, the vibration unit 34 is confined within the compartment such as the pocket 28 described herein. In some embodiments, the vibration unit 34 is removable from the pocket 28.

In some embodiments, the vibration unit 34 is activated by pressing the towel against a surface of an object or a person. In some embodiments, the vibration unit 34 is adjustable such that the massage action can be lessened or increased, depending upon the desires of the user.

Although it has been mentioned that a hook and loop and/or zipper fastening arrangement has been utilized in the various embodiments of the present invention, other cooperative fastening systems well understood in the art may be used. For example, snaps, hooks, buckles, or buttons may be used to fasten the main body portion 14 to the strap 8 or to dose the pocket 28.

In use, the towel 12 may be grasped witty each hand by the main body ends 4, 6 and manipulated across the user's body as desired. The user can use the towel 12 to easily and safely scrub or wash the user's back, legs, feet, and other parts of the body.

While there has been illustrated and described what is, at present, considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of this disclosure.

1. A towel comprising;
a main body portion comprising a base layer, an absorbent layer, and first and second main body ends;
a strap comprising first and second strap ends;
the main body portion comprising an elongated length of material;
said absorbent layer being adjacent to said base layer;
said absorbent layer being absorbent to water and other fluids;
said first strap end extending from said first main body end; and
said second strap end extending from said second main body end.

2. The towel of claim 1, the absorbent layer comprising a plurality of fiber members.

3. The towel of claim 2, the absorbent layer being removably coupled to said base layer.

4. The towel of claim 3, said base layer comprising a first base layer surface, said first base layer surface comprising cooperative fasteners;
said absorbent layer comprising a lower surface, said lower surface comprising cooperative fasteners.

5. The towel of claim 2, one or more of said fiber members comprising an elongated string-like projection.

6. The towel of claim 1, said straps and base layer being formed from a single, unbroken length of material.

7. The towel of claim 1, the absorbent layer comprising a plurality of fiber members.

8. The towel of claim 1, further comprising a pocket.

9. The towel of claim 8, said towel pocket being adapted for use with a hot/cold pack.

10. The towel of claim 8, said towel pocket being adapted for use with a vibration unit.

11. The towel of claim 1, said towel further comprising a hand towel, said hand towel being removeabty coupled to said main body portion.

12. A massage device comprising:
a main body portion comprising a base layer, an outer layer, and first and second main body ends;
a strap comprising first and second strap ends;
the main body portion comprising an elongated length of material;
said outer layer being adjacent to said base layer;
said outer layer comprising a compartment, said compartment comprising a vibration unit, said vibration unit;
said first strap end extending from said first main body end; and
said second strap end extending from said second main body end.

13. The massage device of claim 12, said compartment comprising sides defining an opening, said sides each comprising cooperative coupling members such that said opening can be closed and opened.

14. The massage device of claim 13, said vibration unit being removable from said compartment.

15. The massage device of claim 14, said strap being removable from said main body.
